(19) United States
(12) Patent Application Publication
(10) Pub. No.: US 2026/0141892 A1
(43) Pub. Date: May 21, 2026

(54) METHODS AND SYSTEMS FOR SUPPORT OF MULTI-LANGUAGE USER SESSIONS AND FULFILLMENTS

(71) Applicant: Automation Anywhere, Inc., San Jose, CA (US)

(72) Inventors: Muddu SUDHAKAR, Saratoga, CA (US); Antonio NUCCI, San Jose, CA (US); Christos TRYFONAS, Foster City, CA (US); Purushottam AMRADKAR, Sammamish, WA (US)

(21) Appl. No.: 18/962,486

(22) Filed: Nov. 27, 2024

Related U.S. Application Data
(60) Provisional application No. 63/604,347, filed on Nov. 30, 2023.

(51) Int. Cl. G10L 15/00; G10L 15/22

(52) U.S. Cl. CPC G10L 15/005; G10L 15/22; G10L 2015/223; G10L 2015/225

(57) ABSTRACT

Described herein are methods, systems, and media for supporting multi-language user sessions and fulfillments comprising: maintaining a repository of fulfillment objects each comprising a language and a region; establishing a user session with a user; determining a user region for the user in association with establishing the user session; identifying one or more fulfillment objects in the repository available for the user region; processing the user session, the user session comprising one or more user requests; applying a language detection model to each request to determine a user request spoken language; applying an understanding module to each request to recommend one or more of the fulfillment objects matching the region for the user; and rendering a response to each request to the user, utilizing the one or more of the fulfillment objects matching the region for the user, in the user request spoken language.

### CROSS-REFERENCE

This application claims the benefit of U.S. Provisional Application No. 63/604,347, filed Nov. 30, 2023, which is hereby incorporated by reference in its entirety herein for all purposes.

### BACKGROUND

Generative artificial intelligence (AI) is artificial intelligence capable of generating text, images, or other media, using generative models. Advances in transformer-based deep neural networks have enabled a number of generative AI systems notable for accepting natural language prompts as input. One such type of model, a large language model (LLM), is a deep learning algorithm that can recognize, summarize, translate, predict and generate text and other forms of content based on knowledge gained from massive datasets. LLMs cans improve enterprise operations, making them more efficient, accurate, and personalized.

### SUMMARY

In one aspect, disclosed herein are computer-implemented methods for supporting multi-language user sessions and fulfillments comprising: maintaining a repository of fulfillment objects each comprising a language and a region; establishing a user session with a user; determining a user region for the user in association with establishing the user session; identifying one or more fulfillment objects in the repository available for the user region; processing the user session, the user session comprising one or more user requests; applying a language detection model to each request to determine a user request spoken language; applying an understanding module to each request to recommend one or more of the fulfillment objects matching the region for the user; and rendering a response to each request to the user, utilizing the one or more of the fulfillment objects matching the region for the user, in the user request spoken language. In some embodiments, the method is performed in an automated software pipeline. In further embodiments, the software pipeline is in communication with a generative AI application. In still further embodiments, the generative AI application is an chatbot or an conversational virtual assistant. In some embodiments, the repository of fulfillment objects is maintained for responding to user requests to the generative AI application. In some embodiments, the language detection model is a large language model (LLM). In some embodiments, the understanding module comprises intent-based functionality and intent-less functionality, and wherein the understanding module selects a functionality based at least in part on an Access Control List (ACL) policy. In some embodiments, the understanding module comprises an intent-based understanding module. In further embodiments, the intent-based understanding module comprises a classifier trained on a set of user intents in a model native language, wherein each intent is associated with one or more of the fulfillment objects. In still further embodiments, the intent-based understanding module is configured to perform on-the-fly translation of the user request to the model native language. In some embodiments, the method further comprises performing on-the-fly translation of one or more fulfillment objects recommended by the intent-based understanding module to the user request spoken language. In some embodiments, the understanding module comprises an intent-less understanding module. In further embodiments, the intent-less understanding module comprises a recommendation system trained in a model native language to recommend the most relevant fulfilment object. In still further embodiments, the method further comprises performing on-the-fly translation of the fulfillment objects in the repository available for the user region to the model native language. In various embodiments, the fulfillment objects comprise one or more of: action flows, conversational flows, custom messages, knowledge articles, and service catalogs. In some embodiments, the fulfillment objects comprise knowledge articles, and wherein the method further comprises: translating the knowledge articles offline and out-of-band into a plurality of languages; and storing the translated knowledge articles in the repository of fulfillment objects. In some embodiments, the fulfillment objects comprise knowledge articles, and wherein the method further comprises: maintaining each knowledge article as distinct components comprising a structural template and content; translating the content of a knowledge article recommend by the understanding module on-the-fly into the user request spoken language; and combining the template and the content to provide the user in response to the request. In some embodiments, the method comprises per-request language processing, allowing one or more changes in user request spoken language during the user session without disrupting functionality of the understanding module. In some embodiments, the method minimizes on-the-fly translation to preserve computing resources.

In another aspect, disclosed herein are computer-implemented systems comprising at least one processor and instructions causing the at least one processor to perform operations comprising: maintaining a repository of fulfillment objects each comprising a language and a region; establishing a user session with a user; determining a user region for the user in association with establishing the user session; identifying one or more fulfillment objects in the repository available for the user region; processing the user session, the user session comprising one or more user requests; applying a language detection model to each request to determine a user request spoken language; applying an understanding module to each request to recommend one or more of the fulfillment objects matching the region for the user; and rendering a response to each request to the user, utilizing the one or more of the fulfillment objects matching the region for the user, in the user request spoken language. In some embodiments, the operations are performed in an automated software pipeline. In further embodiments, the software pipeline is in communication with a generative AI application. In still further embodiments, the generative AI application is an chatbot or an conversational virtual assistant. In some embodiments, the repository of fulfillment objects is maintained for responding to user requests to the generative AI application. In some embodiments, the language detection model is a large language model (LLM). In some embodiments, the understanding module comprises intent-based functionality and intent-less functionality, and wherein the understanding module selects a functionality based at least in part on an Access Control List (ACL) policy. In some embodiments, the understanding module comprises an intent-based understanding module. In further embodiments, the intent-based understanding module comprises a classifier trained on a set of user intents in a model native language, wherein each intent is associated with one or more of the fulfillment objects. In still further embodiments, the intent-based understanding module is configured to perform on-the-fly translation of the user request to the model native language. In some embodiments, the operations further comprise performing on-the-fly translation of one or more fulfillment objects recommended by the intent-based understanding module to the user request spoken language. In some embodiments, the understanding module comprises an intent-less understanding module. In further embodiments, the intent-less understanding module comprises a recommendation system trained in a model native language to recommend the most relevant fulfilment object. In still further embodiments, the operations further comprise performing on-the-fly translation of the fulfillment objects in the repository available for the user region to the model native language. In various embodiments, the fulfillment objects comprise one or more of: action flows, conversational flows, custom messages, knowledge articles, and service catalogs. In some embodiments, the fulfillment objects comprise knowledge articles, and wherein the operations further comprise: translating the knowledge articles offline and out-of-band into a plurality of languages; and storing the translated knowledge articles in the repository of fulfillment objects. In some embodiments, the fulfillment objects comprise knowledge articles, and wherein the operations further comprise: maintaining each knowledge article as distinct components comprising a structural template and content; translating the content of a knowledge article recommend by the understanding module on-the-fly into the user request spoken language; and combining the template and the content to provide the user in response to the request. In some embodiments, the operations further comprise per-request language processing, allowing one or more changes in user request spoken language during the user session without disrupting functionality of the understanding module. In some embodiments, the operations minimize on-the-fly translation to preserve computing resources.

In yet another aspect, disclosed herein are one or more non-transitory computer-readable storage media encoded with instructions executable by one or more processors to provide an application comprising a repository of fulfillment objects each comprising a language and a region; a software module establishing a user session with a user; a software module determining a user region for the user in association with establishing the user session; a software module identifying one or more fulfillment objects in the repository available for the user region; a software module processing the user session, the user session comprising one or more user requests; a software module applying a language detection model to each request to determine a user request spoken language; a software module applying an understanding module to each request to recommend one or more of the fulfillment objects matching the region for the user; and a software module rendering a response to each request to the user, utilizing the one or more of the fulfillment objects matching the region for the user, in the user request spoken language.

### BRIEF DESCRIPTION OF THE DRAWINGS

The novel features of the disclosure are set forth with particularity in the appended claims. A better understanding of the features and advantages of the present disclosure will be obtained by reference to the following detailed description that sets forth illustrative embodiments, in which the principles of the disclosure are utilized, and the accompanying drawings of which:

FIG. 1 shows a non-limiting example of a computing device; in this case, a device with one or more processors, memory, storage, and a network interface, per one or more embodiments herein;

FIG. 2 shows a first diagram of an exemplary technology stack, per one or more embodiments herein;

FIG. 3 shows a second diagram of an exemplary technology stack; in this case, a technology stack with large language model (LLM) emphasis;

FIG. 4 shows a diagram of an exemplary method of prompt registration configured at an admin console through an LLM gateway, per one or more embodiments herein;

FIG. 5 shows a non-limiting example of a graphic user interface (GUI); in this case, a GUI for an admin console showing artificial intelligence (AI) service desk features;

FIG. 6 shows a non-limiting example of a GUI; in this case, a GUI for an admin console showing AI ops desk features;

FIG. 7 shows a non-limiting example of a GUI; in this case, a GUI for an admin console showing AI support intelligence features; and

FIG. 8 shows a non-limiting example of a logical architecture; in this case, a logical architecture which uses Language Detection and Translation Services to support Multi-Language User Sessions.

### DETAILED DESCRIPTION

Described herein, in certain embodiments, are computer-implemented methods for supporting multi-language user sessions and fulfillments comprising: maintaining a repository of fulfillment objects each comprising a language and a region; establishing a user session with a user; determining a user region for the user in association with establishing the user session; identifying one or more fulfillment objects in the repository available for the user region; processing the user session, the user session comprising one or more user requests; applying a language detection model to each request to determine a user request spoken language; applying an understanding module to each request to recommend one or more of the fulfillment objects matching the region for the user; and rendering a response to each request to the user, utilizing the one or more of the fulfillment objects matching the region for the user, in the user request spoken language.

Also described herein, in certain embodiments, are computer-implemented systems comprising at least one processor and instructions causing the at least one processor to perform operations comprising: maintaining a repository of fulfillment objects each comprising a language and a region; establishing a user session with a user; determining a user region for the user in association with establishing the user session; identifying one or more fulfillment objects in the repository available for the user region; processing the user session, the user session comprising one or more user requests; applying a language detection model to each request to determine a user request spoken language; applying an understanding module to each request to recommend one or more of the fulfillment objects matching the region for the user; and rendering a response to each request to the user, utilizing the one or more of the fulfillment objects matching the region for the user, in the user request spoken language.

Also described herein, in certain embodiments, are one or more non-transitory computer-readable storage media encoded with instructions executable by one or more processors to provide an application comprising a repository of fulfillment objects each comprising a language and a region; a software module establishing a user session with a user; a software module determining a user region for the user in association with establishing the user session; a software module identifying one or more fulfillment objects in the repository available for the user region; a software module processing the user session, the user session comprising one or more user requests; a software module applying a language detection model to each request to determine a user request spoken language; a software module applying an understanding module to each request to recommend one or more of the fulfillment objects matching the region for the user; and a software module rendering a response to each request to the user, utilizing the one or more of the fulfillment objects matching the region for the user, in the user request spoken language.

### Terms and Definitions

Unless otherwise defined, all technical terms used herein have the same meaning as commonly understood by one of ordinary skill in the art to which this disclosure belongs.

As used herein, the singular forms “a,” “an,” and “the” include plural references unless the context clearly dictates otherwise. Any reference to “or” herein is intended to encompass “and/or” unless otherwise stated.

As used herein, the term “about” in some cases refers to an amount that is approximately the stated amount, in some cases near the stated amount by 10%, 5%, or 1%, including increments therein, and in some cases, in reference to a percentage, refers to an amount that is greater or less the stated percentage by 10%, 5%, or 1%, including increments therein.

As used herein, the phrases “at least one,” “one or more,” and “and/or” are open-ended expressions that are both conjunctive and disjunctive in operation. For example, each of the expressions “at least one of A, B, and C,” “at least one of A, B, or C,” “one or more of A, B, and C,” “one or more of A, B, or C,” and “A, B, and/or C” means A alone, B alone, C alone, A and B together, A and C together, B and C together, or A, B, and C together.

Reference throughout this specification to “some embodiments,” “further embodiments,” or “a particular embodiment,” means that a particular feature, structure, or characteristic described in connection with the embodiment is included in at least one embodiment. Thus, the appearances of the phrase “in some embodiments,” or “in further embodiments,” or “in a particular embodiment” in various places throughout this specification are not necessarily all referring to the same embodiment. Furthermore, the particular features, structures, or characteristics may be combined in any suitable manner in one or more embodiments.

### Computing Systems

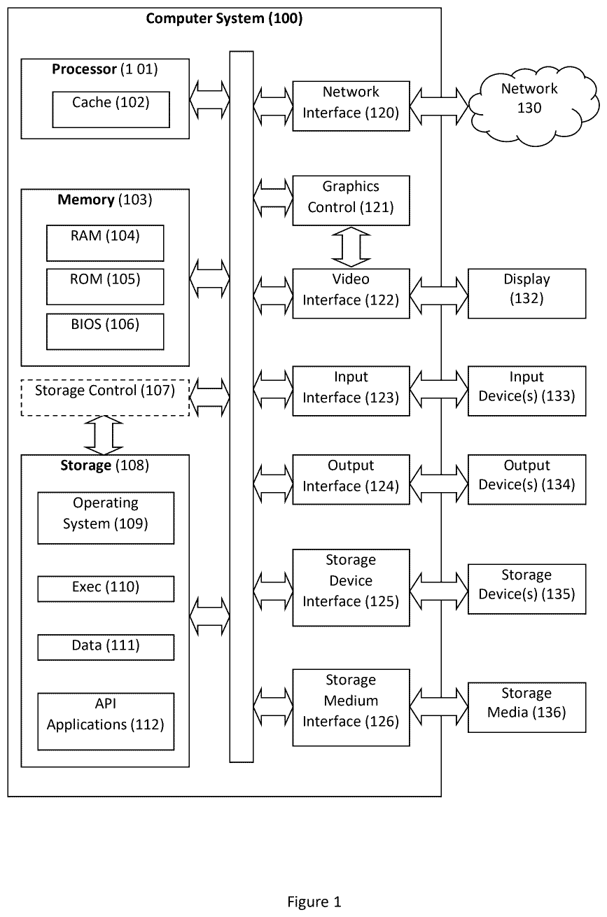

Referring to FIG. 1, a block diagram is shown depicting an exemplary machine that includes a computer system 100 (e.g., a processing or computing system) within which a set of instructions can execute for causing a device to perform or execute any one or more of the aspects and/or methodologies for static code scheduling of the present disclosure. The components in FIG. 1 are examples only and do not limit the scope of use or functionality of any hardware, software, embedded logic component, or a combination of two or more such components implementing particular embodiments.

Computer system 100 may include one or more processors 101, a memory 103, and a storage 108 that communicate with each other, and with other components, via a bus 140. The bus 140 may also link a display 132, one or more input devices 133 (which may, for example, include a keypad, a keyboard, a mouse, a stylus, etc.), one or more output devices 134, one or more storage devices 135, and various tangible storage media 136. All of these elements may interface directly or via one or more interfaces or adaptors to the bus 140. For instance, the various tangible storage media 136 can interface with the bus 140 via storage medium interface 126. Computer system 100 may have any suitable physical form, including but not limited to one or more integrated circuits (ICs), printed circuit boards (PCBs), mobile handheld devices (such as mobile telephones or PDAs), laptop or notebook computers, distributed computer systems, computing grids, or servers.

Computer system 100 includes one or more processor(s) 101 (e.g., central processing units (CPUs) or general purpose graphics processing units (GPGPUs)) that carry out functions. Processor(s) 101 optionally contains a cache memory unit 102 for temporary local storage of instructions, data, or computer addresses. Processor(s) 101 are configured to assist in execution of computer readable instructions. Computer system 100 may provide functionality for the components depicted in FIG. 1 as a result of the processor(s) 101 executing non-transitory, processor-executable instructions embodied in one or more tangible computer-readable storage media, such as memory 103, storage 108, storage devices 135, and/or storage medium 136. The computer-readable media may store software that implements particular embodiments, and processor(s) 101 may execute the software. Memory 103 may read the software from one or more other computer-readable media (such as mass storage device(s) 135, 136) or from one or more other sources through a suitable interface, such as network interface 120. The software may cause processor(s) 101 to carry out one or more processes or one or more steps of one or more processes described or illustrated herein. Carrying out such processes or steps may include defining data structures stored in memory 103 and modifying the data structures as directed by the software.

The memory 103 may include various components (e.g., machine readable media) including, but not limited to, a random access memory component (e.g., RAM 104) (e.g., static RAM (SRAM), dynamic RAM (DRAM), ferroelectric random access memory (FRAM), phase-change random access memory (PRAM), etc.), a read-only memory component (e.g., ROM 105), and any combinations thereof. ROM 105 may act to communicate data and instructions unidirectionally to processor(s) 101, and RAM 104 may act to communicate data and instructions bidirectionally with processor(s) 101. ROM 105 and RAM 104 may include any suitable tangible computer-readable media described below. In one example, a basic input/output system 106 (BIOS), including basic routines that help to transfer information between elements within computer system 100, such as during start-up, may be stored in the memory 103.

Fixed storage 108 is connected bidirectionally to processor(s) 101, optionally through storage control unit 107. Fixed storage 108 provides additional data storage capacity and may also include any suitable tangible computer-readable media described herein. Storage 108 may be used to store operating system 109, executable(s) 110, data 111, applications 112 (application programs), and the like. Storage 108 can also include an optical disk drive, a solid-state memory device (e.g., flash-based systems), or a combination of any of the above. Information in storage 108 may, in appropriate cases, be incorporated as virtual memory in memory 103.

In one example, storage device(s) 135 may be removably interfaced with computer system 100 (e.g., via an external port connector (not shown)) via a storage device interface 125. Particularly, storage device(s) 135 and an associated machine-readable medium may provide non-volatile and/or volatile storage of machine-readable instructions, data structures, program modules, and/or other data for the computer system 100. In one example, software may reside, completely or partially, within a machine-readable medium on storage device(s) 135. In another example, software may reside, completely or partially, within processor(s) 101.

Bus 140 connects a wide variety of subsystems. Herein, reference to a bus may encompass one or more digital signal lines serving a common function, where appropriate. Bus 140 may be any of several types of bus structures including, but not limited to, a memory bus, a memory controller, a peripheral bus, a local bus, and any combinations thereof, using any of a variety of bus architectures. As an example and not by way of limitation, such architectures include an Industry Standard Architecture (ISA) bus, an Enhanced ISA (EISA) bus, a Micro Channel Architecture (MCA) bus, a Video Electronics Standards Association local bus (VLB), a Peripheral Component Interconnect (PCI) bus, a PCI-Express (PCI-X) bus, an Accelerated Graphics Port (AGP) bus, HyperTransport (HTX) bus, serial advanced technology attachment (SATA) bus, and any combinations thereof.

Computer system 100 may also include an input device 133. In one example, a user of computer system 100 may enter commands and/or other information into computer system 100 via input device(s) 133. Examples of an input device(s) 133 include, but are not limited to, an alpha-numeric input device (e.g., a keyboard), a pointing device (e.g., a mouse or touchpad), a touchpad, a touch screen, a multi-touch screen, a joystick, a stylus, a gamepad, an audio input device (e.g., a microphone, a voice response system, etc.), an optical scanner, a video or still image capture device (e.g., a camera), and any combinations thereof. In some embodiments, the input device is a Kinect, Leap Motion, or the like. Input device(s) 133 may be interfaced to bus 140 via any of a variety of input interfaces 123 (e.g., input interface 123) including, but not limited to, serial, parallel, game port, USB, FIREWIRE, THUNDERBOLT, or any combination of the above.

In particular embodiments, when computer system 100 is connected to network 130, computer system 100 may communicate with other devices, specifically mobile devices and enterprise systems, distributed computing systems, cloud storage systems, cloud computing systems, and the like, connected to network 130. Communications to and from computer system 100 may be sent through network interface 120. For example, network interface 120 may receive incoming communications (such as requests or responses from other devices) in the form of one or more packets (such as Internet Protocol (IP) packets) from network 130, and computer system 100 may store the incoming communications in memory 103 for processing. Computer system 100 may similarly store outgoing communications (such as requests or responses to other devices) in the form of one or more packets in memory 103 and communicated to network 130 from network interface 120. Processor(s) 101 may access these communication packets stored in memory 103 for processing.

Examples of the network interface 120 include, but are not limited to, a network interface card, a modem, and any combination thereof. Examples of a network 130 or network segment 130 include, but are not limited to, a distributed computing system, a cloud computing system, a wide area network (WAN) (e.g., the Internet, an enterprise network), a local area network (LAN) (e.g., a network associated with an office, a building, a campus or other relatively small geographic space), a telephone network, a direct connection between two computing devices, a peer-to-peer network, and any combinations thereof. A network, such as network 130, may employ a wired and/or a wireless mode of communication. In general, any network topology may be used.

Information and data can be displayed through a display 132. Examples of a display 132 include, but are not limited to, a cathode ray tube (CRT), a liquid crystal display (LCD), a thin film transistor liquid crystal display (TFT-LCD), an organic liquid crystal display (OLED) such as a passive-matrix OLED (PMOLED) or active-matrix OLED (AMOLED) display, a plasma display, and any combinations thereof. The display 132 can interface to the processor(s) 101, memory 103, and fixed storage 108, as well as other devices, such as input device(s) 133, via the bus 140. The display 132 is linked to the bus 140 via a video interface 122, and transport of data between the display 132 and the bus 140 can be controlled via the graphics control 121. In some embodiments, the display is a video projector. In some embodiments, the display is a head-mounted display (HMD) such as a VR headset. In further embodiments, suitable VR headsets include, by way of non-limiting examples, HTC Vive, Oculus Rift, Samsung Gear VR, Microsoft HoloLens, Razer OSVR, FOVE VR, Zeiss VR One, Avegant Glyph, Freefly VR headset, and the like. In still further embodiments, the display is a combination of devices such as those disclosed herein.

In addition to a display 132, computer system 100 may include one or more other peripheral output devices 134 including, but not limited to, an audio speaker, a printer, a storage device, and any combinations thereof. Such peripheral output devices may be connected to the bus 140 via an output interface 124. Examples of an output interface 124 include, but are not limited to, a serial port, a parallel connection, a USB port, a FIREWIRE port, a THUNDERBOLT port, and any combinations thereof.

In addition or as an alternative, computer system 100 may provide functionality as a result of logic hardwired or otherwise embodied in a circuit, which may operate in place of or together with software to execute one or more processes or one or more steps of one or more processes described or illustrated herein. Reference to software in this disclosure may encompass logic, and reference to logic may encompass software. Moreover, reference to a computer-readable medium may encompass a circuit (such as an IC) storing software for execution, a circuit embodying logic for execution, or both, where appropriate. The present disclosure encompasses any suitable combination of hardware, software, or both.

Those of skill in the art will appreciate that the various illustrative logical blocks, modules, circuits, and algorithm steps described in connection with the embodiments disclosed herein may be implemented as electronic hardware, computer software, or combinations of both. To clearly illustrate this interchangeability of hardware and software, various illustrative components, blocks, modules, circuits, and steps have been described above generally in terms of their functionality.

The various illustrative logical blocks, modules, and circuits described in connection with the embodiments disclosed herein may be implemented or performed with a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general purpose processor may be a microprocessor, but in the alternative, the processor may be any conventional processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

The steps of a method or algorithm described in connection with the embodiments disclosed herein may be embodied directly in hardware, in a software module executed by one or more processor(s), or in a combination of the two. A software module may reside in RAM memory, flash memory, ROM memory, EPROM memory, EEPROM memory, registers, hard disk, a removable disk, a CD-ROM, or any other form of storage medium known in the art. An exemplary storage medium is coupled to the processor such the processor can read information from, and write information to, the storage medium. In the alternative, the storage medium may be integral to the processor. The processor and the storage medium may reside in an ASIC. The ASIC may reside in a user terminal. In the alternative, the processor and the storage medium may reside as discrete components in a user terminal.

In accordance with the description herein, suitable computing devices include, by way of non-limiting examples, cloud computing platforms, distributed computing platforms, server clusters, server computers, desktop computers, laptop computers, notebook computers, sub-notebook computers, netbook computers, and netpad computers.

In some embodiments, the computing device includes an operating system configured to perform executable instructions. The operating system is, for example, software, including programs and data, which manages the device's hardware and provides services for execution of applications. Those of skill in the art will recognize that suitable server operating systems include, by way of non-limiting examples, FreeBSD, OpenBSD, NetBSD®, Linux, Apple® Mac OS X Server®, Oracle® Solaris®, Windows Server®, and Novell® NetWare®. Those of skill in the art will recognize that suitable personal computer operating systems include, by way of non-limiting examples, Microsoft® Windows®, Apple® Mac OS X®, UNIX®, and UNIX-like operating systems such as GNU/Linux® In some embodiments, the operating system is provided by cloud computing. Those of skill in the art will also recognize that suitable mobile smartphone operating systems include, by way of non-limiting examples, Nokia® Symbian® OS, Apple® iOS®, Research In Motion® BlackBerry OS®, Google® Android®, Microsoft® Windows Phone® OS, Microsoft® Windows Mobile® OS, Linux®, and Palm® WebOS®.

### Non-Transitory Computer Readable Storage Medium

In some embodiments, the platforms, systems, media, and methods disclosed herein include one or more non-transitory computer readable storage media encoded with a program including instructions executable by the operating system of an optionally networked computing device. In further embodiments, a computer readable storage medium is a tangible component of a computing device. In still further embodiments, a computer readable storage medium is optionally removable from a computing device. In some embodiments, a computer readable storage medium includes, by way of non-limiting examples, CD-ROMs, DVDs, flash memory devices, solid state memory, magnetic disk drives, magnetic tape drives, optical disk drives, distributed computing systems including cloud computing systems and services, and the like. In some cases, the program and instructions are permanently, substantially permanently, semi-permanently, or non-transitorily encoded on the media.

### Computer Programs

In some embodiments, the platforms, systems, media, and methods disclosed herein include at least one computer program, or use of the same. A computer program includes a sequence of instructions, executable by one or more processor(s) of the computing device's CPU, written to perform a specified task. Computer readable instructions may be implemented as program modules, such as functions, objects, Application Programming Interfaces (APIs), computing data structures, and the like, which perform particular tasks or implement particular abstract data types. In light of the disclosure provided herein, those of skill in the art will recognize that a computer program may be written in various versions of various languages.

The functionality of the computer readable instructions may be combined or distributed as desired in various environments. In some embodiments, a computer program comprises one sequence of instructions. In some embodiments, a computer program comprises a plurality of sequences of instructions. In some embodiments, a computer program is provided from one location. In other embodiments, a computer program is provided from a plurality of locations. In various embodiments, a computer program includes one or more software modules. In various embodiments, a computer program includes, in part or in whole, one or more web applications, one or more mobile applications, one or more standalone applications, one or more web browser plug-ins, extensions, add-ins, or add-ons, or combinations thereof.

### Software Modules

In some embodiments, the platforms, systems, media, and methods disclosed herein include software, server, and/or database modules, or use of the same. In view of the disclosure provided herein, software modules are created by techniques known to those of skill in the art using machines, software, and languages known to the art. The software modules disclosed herein are implemented in a multitude of ways. In various embodiments, a software module comprises a file, a section of code, a programming object, a programming structure, a distributed computing resource, a cloud computing resource, or combinations thereof. In further various embodiments, a software module comprises a plurality of files, a plurality of sections of code, a plurality of programming objects, a plurality of programming structures, a plurality of distributed computing resources, a plurality of cloud computing resources, or combinations thereof. In various embodiments, the one or more software modules comprise, by way of non-limiting examples, a web application, a mobile application, a standalone application, and a distributed or cloud computing application. In some embodiments, software modules are in one computer program or application. In other embodiments, software modules are in more than one computer program or application. In some embodiments, software modules are hosted on one machine. In other embodiments, software modules are hosted on more than one machine. In further embodiments, software modules are hosted on a distributed computing platform such as a cloud computing platform. In some embodiments, software modules are hosted on one or more machines in one location. In other embodiments, software modules are hosted on one or more machines in more than one location.

### Databases

In some embodiments, the platforms, systems, media, and methods disclosed herein include one or more databases, or use of the same. In view of the disclosure provided herein, those of skill in the art will recognize that many databases are suitable for storage and retrieval of, for example, user, session, request, language, model, fulfillment object, region, and response information. In various embodiments, suitable databases include, by way of non-limiting examples, relational databases, non-relational databases, object oriented databases, object databases, entity-relationship model databases, associative databases, XML databases, document oriented databases, and graph databases. Further non-limiting examples include SQL, PostgreSQL, MySQL, Oracle, DB2, Sybase, and MongoDB. In some embodiments, a database is Internet-based. In further embodiments, a database is web-based. In still further embodiments, a database is cloud computing-based. In a particular embodiment, a database is a distributed database. In other embodiments, a database is based on one or more local computer storage devices.

### LLM Technology Stack

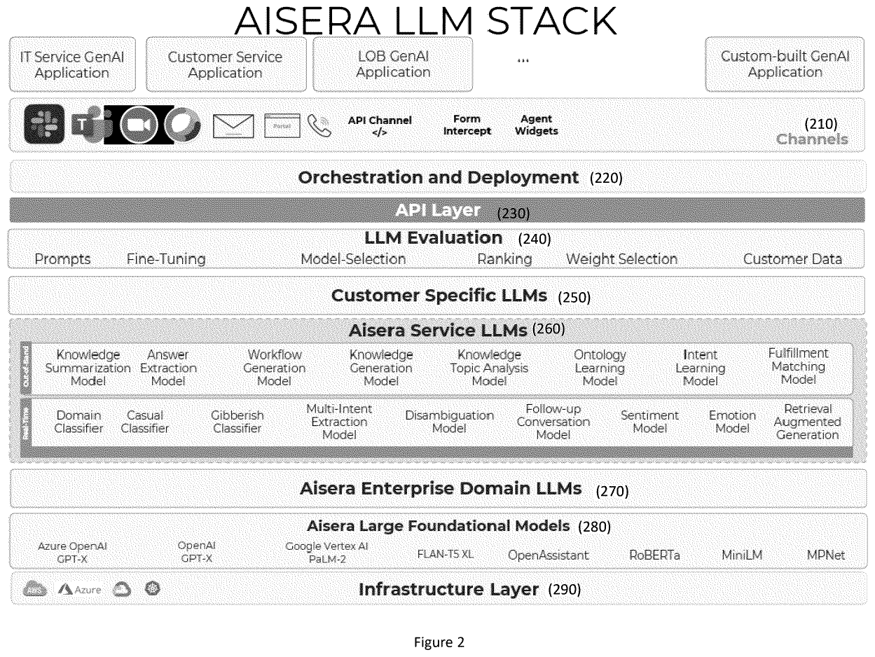

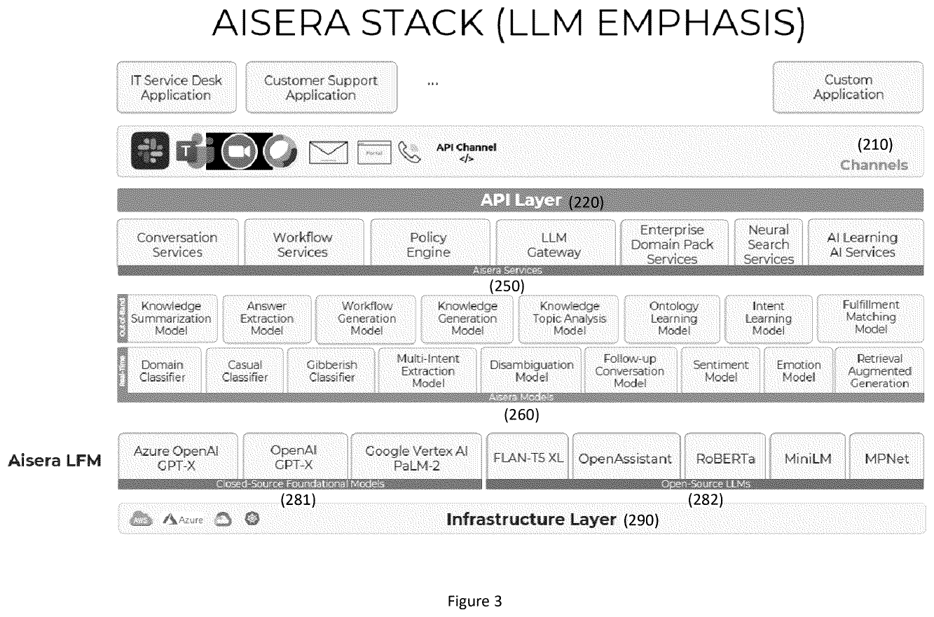

FIGS. 2 and 3 show diagrams of an exemplary Large Language Model (LLM) Technology Stack. In some embodiments, the LLM stack herein can be deployed, scaled and operated both in public clouds (AWS, GCP, Azure, etc.) on an Infrastructure Layer 290 and locally (on-premise) using the Kubernetes container orchestration platform.

In some embodiments, the LLM stack herein embeds a plurality of large foundational models (LFMs) 280, including both closed-source LFMs 281 via an API layer 230 integrated with LFMs, and open-source LFMs 282 via the LFM deployment and execution in secure Kubernetes containers. Non-limiting examples of closed-source LFM providers which are integrated with The LLM stack herein via APIs are Azure OpenAI (complete and chat APIs for GPT-3, GPT-3.5, and GPT-4), OpenAI (complete and chat APIs for GPT-3, GPT-3.5 and GPT-4), Google Vertex AI (PaLM-2). Non-limiting examples of open-source LFM are FLAN-T5, OpenAssistant, ROBERTa, MiniLM, and MPNet.

In some embodiments, the LLM stack herein enables a developer to choose from a pool of supported LFM/LLM models using a catalog, or to integrate a new LFM/LLM model using the LLM Gateway. In some embodiments, the LLM Gateway Toolkit allows the developer to select the LFM provider of choice, either from a catalog or by selecting “New LFM” (in which case he needs to provide the LFM Provider URL and the API Credentials to establish a successful connection), create a new LLM Group, which is a logical folder associated to the developer, and simply upload the new LLM models in the LLM group.

The LLM stack herein provides the developer with the flexibility of choosing both the LFM framework and a customer-specific LLM model 250 for any given task based on the different LLM services needed to operate a conversational AI assistant. As a result, in some embodiments, developers can develop end to end LLM workflows or LLM services 260 which comprise more than one task by choosing a specific LFM/LLM model for each specific task to be executed in the pipeline.

In some embodiments, developers can calibrate each model per their objectives to deliver a high level of precision and accuracy. In some embodiments, LLM stack herein allows the developer to calibrate the mode using the below behaviors:
Zero-shot Learning: The developer can use the pre-trained LLM model as-is. Examples of such tasks are language detection, language translation, sentiment detection, emotion detection, etc.
Few-shots Learning (e.g., prompt engineering or inference-time tuning): In some embodiments, the developer guides the model to the desired output by providing the LLM model with few examples and instructions. In some embodiments, this calibration model does not alter the underlying parameters of the LLM models.
Instruction-based Fine-Tuning: This method may provide a higher level of precision and accuracy than zero-shot or few-shot learnings. In some embodiments, in this method, the developer trains the model using specialized datasets, which are high-quality human-generated prompt/response pairs specifically designed for instruction tuning LLMs. In some embodiments, this method of calibration acts deeper in the LLM model by updating the internal parameters used by the model. The model fine-tuning is the most advanced calibration method and may require both computing resources for training and supervised, high-quality and extensive datasets to generate the prompt/response sentence pairs for training.

In some embodiments, the Large Language Model (LLM) technology stack herein can operate in multiple industry verticals (e.g., logistics, healthcare, wealth management, retailers, banking, airlines, and insurance) and enterprise domains 270 (e.g., IT, HR, legal and compliance, finance, supply chain management, facilities). The Enterprise Domain LLMs are LLM models which have been extensively fine-tuned using prompt/response sentence pairs extracted from Enterprise Domain Packs (EDPs). In some embodiments, each Enterprise Domain Pack comprises a domain-specific ontology, which is an extensive set of entity classes, entity names, entity synonymous like entity expansions, and abbreviations (initialisms, acronymous, shortenings and contractions) and domain-specific taxonomy, which is an extensive set of intents (and intent phrases) associated to each entity of the ontology. Each domain EDP may comprise hundreds of thousands to millions of intent phrases.

In some embodiments, the Large Language Model (LLM) technology stacks herein use pre-packaged and fine-tuned a large pool of domain-specific LLM Services 260 using one or more EDPs. The LLM Services 260 may be available to developers in a Service LLM catalog. In some embodiments, the developer uses the LLM Services 260 via an API, or can select or drag/drop/chain them into a conversational workflow using a studio to build complete experiences around a service.

In some embodiments, the LLM stack herein provides a further level of LLM model customization beyond the calibration offered via the instruction-fine tuning and EDP. The Large Language Model (LLM) technology stack herein offers special learning pipelines, which act on the specific customer datasets (e.g., tickets, knowledge articles, call transcripts, etc.) which may automatically extract entities and intents which are very specific to the customer (e.g., within the domain of operation). In some embodiments, this custom-specific knowledge is then used to generate custom-specific prompt/responses which may then be used to execute a second round of instruction-based fine tuning on a proprietary Enterprise Domain LLMs, which may be fine-tuned using only the domain-specific EDPs. Exemplary proprietary AI Learning pipelines directly linked to instruction-based fine-tuning pf LLM models are listed below:
Tickets Learning Pipeline: Iteratively and continuously processes tickets and automatically extracts the main entities and associated intents. By grouping tickets tagged with the same pair of intents and entities, the pipeline may automatically generate intent phrases capturing the language diversity used by the specific customer to express the same concept.
Conversation Learning Pipeline: Iteratively and continuously processes user requests and calls transcripts, and automatically extracts the main entities and associated intents. By grouping conversations tagged with the same pair of intent and entity, the pipeline may automatically generate intent phrases capturing the language diversity used by the specific customer to express the same concept.
Knowledge Learning Pipeline: Processes ingested customer knowledge articles and may automatically extract the main entities, associated intents and large set of intent phrases from each article.
Ontology Generation: Consumes all the entity-based learning from the different pipelines, may automatically discover expansions, abbreviations, and relationships among the entities, and organizes all the entities into an ontology graph which may be made available as a catalog.
Taxonomy Generation: Consumes all the intent-based learning from the different pipelines and may automatically organize all semantic similar intents into a multi-category multi-level intent taxonomy which is made available as a catalog.

In some embodiments, the LLM stack herein provides an LLM evaluation level 240, which the user with a set of toolkits and APIs that developers can use to evaluate the performance of the LLM models herein. Developers can access toolkits and APIs for development, testing and benchmarking the following: prompt engineering (e.g., few shots learning), fine tuning, Model Selection via LLM catalog and LLM Gateway, model performance ranking which automatically scores the models against the same dataset to automatically stack rank LFM/LLM models based on the accuracy achieved, and manage customer datasets for instruction-fine tuning models.

In some embodiments, the LLM stack herein offers a comprehensive Orchestration and Deployment Layer 220 that is used to allocate and deploy resources (including servers, virtual machines, networking, security and storage), monitor software lifecycle operations, and recover from error conditions. In some embodiments, the LLM stack herein offers a large diversity of channels 210 to interface with users like Slack, Microsoft Teams, Cisco WebEx, Zoom, SMS/MMS, Email and Voice), Administrator Portal, Form Intercept and Agent Widgets.

In some embodiments, prompts can have a separate LLM Provider, internal or external (e.g., OpenAI, Bard, etc.). Input Variables can be passed into prompts (e.g. Chat history). In some embodiments, prompt groups and/or prompt chaining is implemented as well.

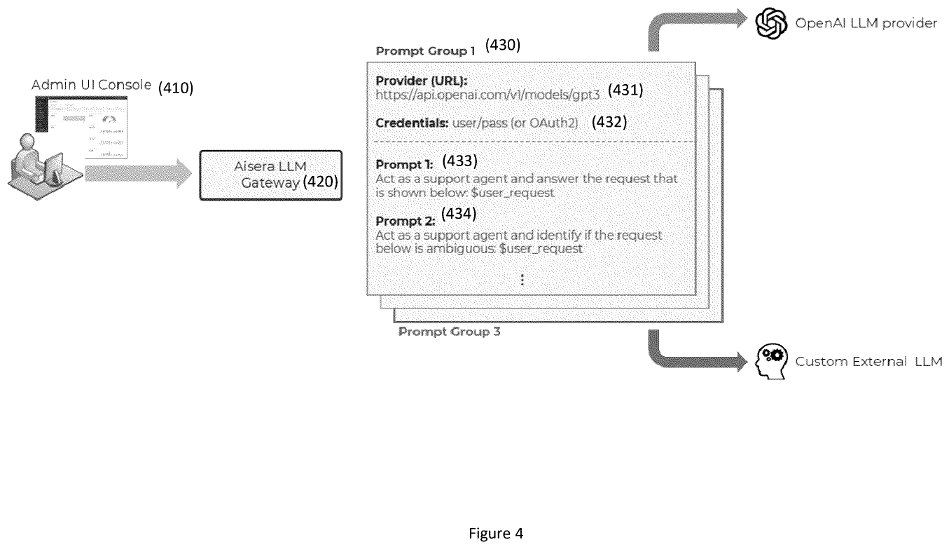

In some embodiments, per FIG. 4, an LLM provider is registered through a LLM Gateway by an Admin UI console 410. In some embodiments, prompts are added that will be used mainly for preconfigured Tasks through the LLM Gateway 420 (e.g., an Admin UI console). In some embodiments, calling the registered prompts can be performed by using a prompt for the main NLU path by inserting them inside the Pre-Handling Flow, or as an auxiliary capacity, by adding prompts inside a flow (e.g., using the new LLM action). In the example shown, a first prompt group 430 comprises a provider URL 431 and the associated credentials 432, a first prompt 433, and a second prompt 434. As shown, the first prompt 433 and the second prompt 434 of the first prompt group 430 are sent to an OpenAI LLM provider 450. Further, a second prompt group 440 is sent based on its provider URL (not shown), to a custom external LLM 460. In some embodiments, the LLM Gateway 420 determines, based on the prompt, the provider URL 431, the associated credentials 432, or any combination thereof whether to send the prompt to the OpenAI LLM provider 450 or to the custom external LLM 460. In some embodiments, the LLM Gateway 420 sends the prompt to the OpenAI LLM provider 450 for general prompts that can be answered by the OpenAI LLM provider 450. In some embodiments, the LLM Gateway 420 sends prompts specific to an organization, an application, or other specialized department to the custom external LLM 460.

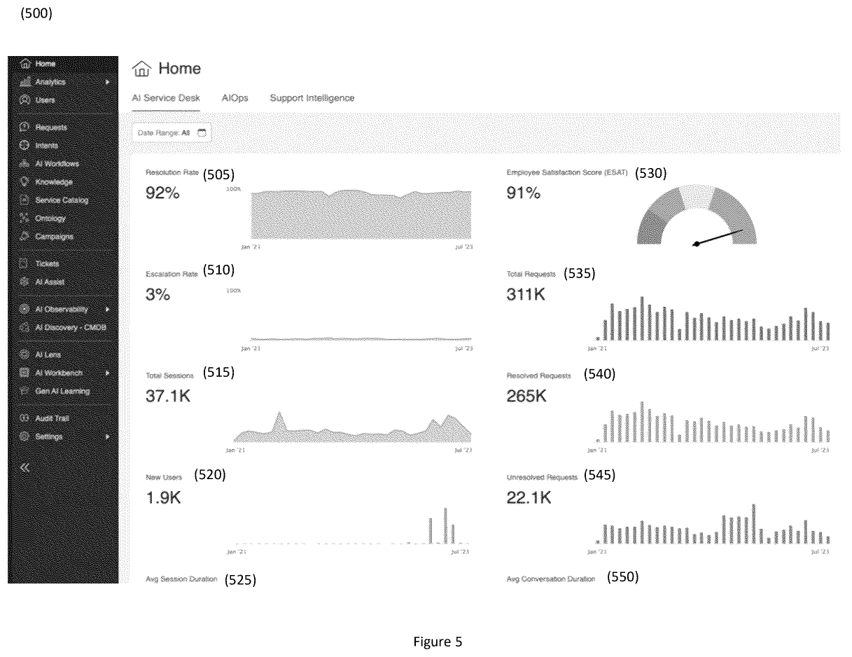

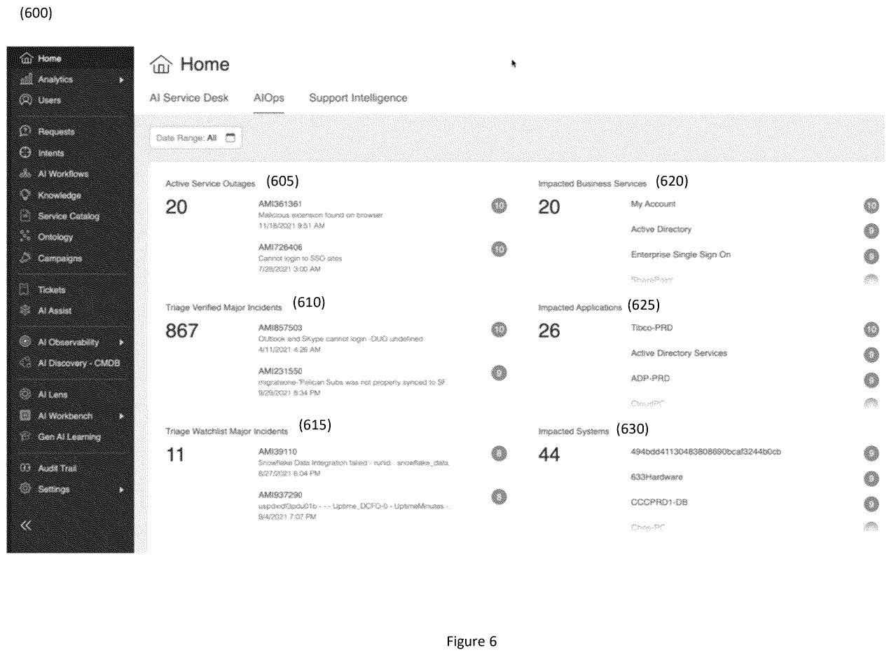

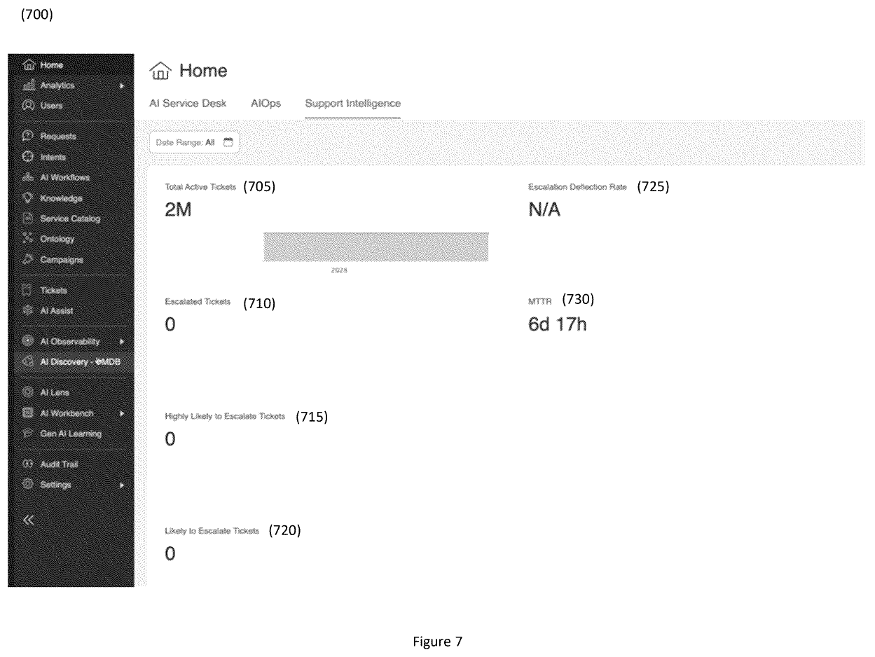

In some embodiments, technology stack described herein includes an administrative (or admin) console. In further embodiments, the admin console includes a front-end interface, such as a GUI. In still further embodiments, the GUI includes features allowing an admin user to review and configure features of the technology described herein. By way of example, in some embodiments, per FIG. 5, a GUI for an admin console 500 includes navigation elements allowing a user to access, by way of examples, analytics, users, requests, intents, AI workflows, knowledge bases, service catalogs, ontologies, campaigns, tickets, AI assist, AI observatory, AI discovery, AI lens, AI workbench, gen AI learning, an audit trail, and settings. Further, in some embodiments, per FIG. 5, a GUI for an admin console 500 includes an AI service deck feature providing access to data pertaining to, for example, resolution rates 505, escalation rates 510, total sessions 515, new users 520, average session duration 525, employee satisfaction score 530, total requests 535, resolved requests 540, unresolved requests 545, and average conversation duration 550. By way of further example, in some embodiments, per FIG. 6, a GUI for an admin console 600 includes an AI ops feature providing access to data pertaining to, for example, active service outages 605, triage verified major incidents 610, triage watchlist major incidents 615, impacted business services 620, impacted applications 625, and impacted systems 630. By way of still further example, in some embodiments, per FIG. 7, a GUI for an admin console 700 includes an support intelligence feature providing access to data pertaining to, for example, total active tickets 705, escalated tickets 710, highly likely to escalate tickets 715, likely to escalate tickets 720, escalation deflection rate 725, and mean time to recovery, repair, respond, or resolve (MTTR) 730.

### Overview

A user session is a collection of user requests. The user session starts when the user authenticates into the system and starts interacting with the system. The user session ends even when the user disconnects from the system or after the user is inactive for a prolonged time (time threshold which is configurable). Within the user session, the user can engage with the system once or multiple times (what input the user enters), which is called a user request. All user requests which relate to the same topic, are called user conversations in the system.

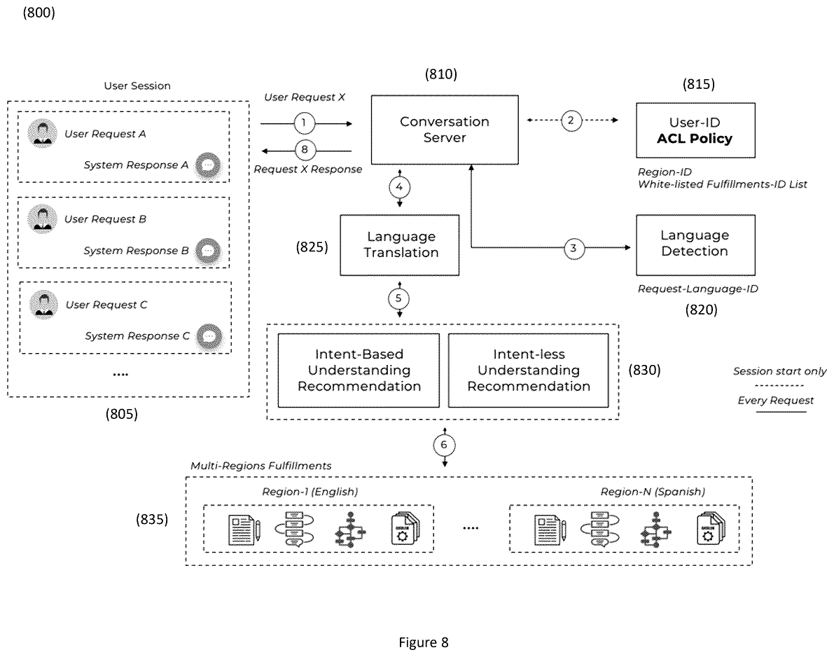

Shown in FIG. 8 is an exemplary end-to-end architecture 800 of the systems described herein. As soon as the user starts a session 805 with the system and places the first user request, the conversation server 810 invokes the ACL policy engine 815 which: (1) performs a look up to the user table to retrieve the region the user belongs to (for example, Spain or Switzerland or China or the United States of America), and (2) generates a list of all fulfillment object IDs, each with its own associated language, available for that region. In some embodiments, this operation (Step 2 in FIG. 8) is executed only at the start of the user session and will not be performed again throughout the user session. The conversation server 810 then passes the user request X to the language detection model 820 (Step 3 in FIG. 8) which detects the language spoken by the user in the user request X. We call this User Request Spoken Language or URSL. The conversation server, based on its configuration policy, can decide how to apply the understanding engine 830, e.g., whether to process the user request using either the intent-based request understanding module, or the intent-less user request understanding module, to identify and prepare one or more fulfillment objects 835 for presentation to the user as a response.

As described herein, in some embodiments, the intent-based understanding module is a classifier which has been trained on a set of user intents and each intent comes with one or more associated fulfillments. Each intent can have as a fulfilment object the following: action flow, conversational flow, custom message, knowledge article, and/or service catalog. As described herein, in some embodiments, the intent-less understanding module is a recommendation system which has been trained to recommend the most relevant fulfilment object in response to a user request. The intent-less recommendation system as well can recommend across a pool of fulfillment objects like action flow, conversational flow, custom message, knowledge article, service catalog.

### Intent-Based Understanding (IBM)

In some cases the configuration policy is set to use the intent-based understanding module to process the user request. In some embodiments, this classification system is trained using a native language. We call the native language used for the Intent-based understanding system IBM (Intent-Based Understanding module) Native Language. For example, an IBM module trained using English is said to have English as its IBM Native Language. In such embodiments, the IBM system is only capable to classify user requests which uses the exact same language as its IBM Native Language. The system proposed herein, in some embodiments, uses a module called Language Translation which verifies that the User Request Spoken Language (URSL) and the IBM Native Language are the same. If not, it will automatically translate the user request to the IBM Native Language.

Accordingly, in some embodiments, the translated user request is then passed to the IBM module for processing, which classifies the translated request using its pool of trained intents, and the triggers the fulfillment execution of the classified intent. Next, it is the rendering of the fulfillments. In further embodiments, first, the fulfilments associated to the intent are checked against the User-ID ACL Policy, which filters fulfillments based on: (1) the region ID of the user (only fulfillments belonging to the user region are eligible for rendering), and (2) the ACL access privileges (only fulfillments within the region that the user has access privileges). The resulting set of fulfilments are then processed by the Language Translation module. This module processes each fulfillment and translates the fulfillment (if needed) to the URSL language. For action and conversational flow, this means all the pre-populated messages used in the flow (like drop-down menu, system messages, etc.) are translated to the URSL language. For knowledge articles, service catalogs and custom message, their content is fully translated to the URSL language. Next, the fulfillments are presented to the user through the conversation server.

### Intent-Less Understanding (ILM)

In some cases the configuration policy is set to use the intent-less understanding module to process the user request. In some embodiments, this recommendation system is trained using a native language. We call the native language used for the Intent-less understanding system ILM (Intent-less Understanding module) Native Language. For example, an ILM module trained using documents and fulfillment definition files in English is said to have English as its ILM Native Language. In such embodiments, the characteristics and properties of ILM Native Language is used during the model training, both at the creation of the embeddings and the indexes. Similarly, to the IBM Module, the ILM module will provide relevant fulfillment recommendations only in response to user requests which have as URSL the same language model used during the model training (i.e., ILM Native Language). The system proposed herein, in some embodiments, takes every ingested knowledge article and fulfillment definition file and translates them to a common ILM Native Language (this is also known as document language normalization process). In doing so, the system can provide its recommendation across the large variety of fulfillment objects while being agnostic to the language that was used to create the fulfillment.

Accordingly, in some embodiments, when the user request is forwarded to the ILM module for processing, the ILM module searches the space of available fulfillment objects only within the same user region (Region-ID). In further embodiments, the recommended fulfillments are checked against the whitelist fulfillment IDs for the user and only the fulfillment for which the user has access privileges are selected. In still further embodiments, the selected fulfillments are then forwarded to the translation service which checks whether the fulfillment language is the same as the URSL, and if not, the fulfillment object is translated to URSL. Next, the fulfillments are rendered back to the user through the conversation server.

### Knowledge Articles as Fulfillments

In some embodiments, knowledge article fulfillment objects are provided in one language only, while the system might need to render the knowledge article in a different spoken language by the user. In some cases, the processes described herein does not preserve the document template, but just translates its content. In some embodiments, the system supports the preservation of the knowledge article templates using two modalities: (1) each knowledge article belonging to a region is pre-translated/pre-formatted in all languages supported in that region. This means that if a region supports N languages, each document in that region will have N copies (one per each language). The ILM Module will then use the knowledge article as a fulfilment which is tagged with the exact same language as the URSL; (2) each knowledge article comes defined with its content and template. In such a scenario, the ILM module will operate as described in IBM embodiments, but the translated content will be used to populate the knowledge article template before rendering it.

While preferred embodiments of the present disclosure have been shown and described herein, it will be obvious to those skilled in the art that such embodiments are provided by way of example only. Numerous variations, changes, and substitutions will now occur to those skilled in the art without departing from the disclosure. It should be understood that various alternatives to the embodiments of the disclosure described herein may be employed in practicing the disclosure.

What is claimed is:

1. A computer-implemented method for supporting multi-language user sessions and fulfillments comprising:
a) maintaining a repository of fulfillment objects each comprising a language and a region;
b) establishing a user session with a user;
c) determining a user region for the user in association with establishing the user session;
d) identifying one or more fulfillment objects in the repository available for the user region;
e) processing the user session, the user session comprising one or more user requests;
f) applying a language detection model to each request to determine a user request spoken language;
g) applying an understanding module to each request to recommend one or more of the fulfillment objects matching the region for the user; and
h) rendering a response to each request to the user, utilizing the one or more of the fulfillment objects matching the region for the user, in the user request spoken language.

2. The method of claim 1, wherein the method is performed in an automated software pipeline.

3. The method of claim 2, wherein the software pipeline is in communication with a generative AI application.

4. The method of claim 3, wherein the generative AI application is an chatbot or an conversational virtual assistant.

5. The method of claim 3, wherein the repository of fulfillment objects is maintained for responding to user requests to the generative AI application.

6. The method of claim 1, wherein the language detection model is a large language model (LLM).

7. The method of claim 1, wherein the understanding module comprises intent-based functionality and intent-less functionality, and wherein the understanding module selects a functionality based at least in part on an Access Control List (ACL) policy.

8. The method of claim 1, wherein the understanding module comprises an intent-based understanding module.

9. The method of claim 8, wherein the intent-based understanding module comprises a classifier trained on a set of user intents in a model native language, wherein each intent is associated with one or more of the fulfillment objects.

10. The method of claim 9, wherein the intent-based understanding module is configured to perform on-the-fly translation of the user request to the model native language.

11. The method of claim 9, further comprising performing on-the-fly translation of one or more fulfillment objects recommended by the intent-based understanding module to the user request spoken language.

12. The method of claim 1, wherein the understanding module comprises an intent-less understanding module.

13. The method of claim 12, wherein the intent-less understanding module comprises a recommendation system trained in a model native language to recommend the most relevant fulfilment object.

14. The method of claim 13, further comprising performing on-the-fly translation of the fulfillment objects in the repository available for the user region to the model native language.

15. The method of claim 1, wherein the fulfillment objects comprise one or more of: action flows, conversational flows, custom messages, knowledge articles, and service catalogs.

16. The method of claim 1, wherein the fulfillment objects comprise knowledge articles, and wherein the method further comprises:
a) translating the knowledge articles offline and out-of-band into a plurality of languages; and
b) storing the translated knowledge articles in the repository of fulfillment objects.

17. The method of claim 1, wherein the fulfillment objects comprise knowledge articles, and wherein the method further comprises:
a) maintaining each knowledge article as distinct components comprising a structural template and content;
b) translating the content of a knowledge article recommend by the understanding module on-the-fly into the user request spoken language; and
c) combining the template and the content to provide the user in response to the request.

18. The method of claim 1, wherein the method comprises per-request language processing, allowing one or more changes in user request spoken language during the user session without disrupting functionality of the understanding module.

19. The method of claim 1, wherein the method minimizes on-the-fly translation to preserve computing resources.

20. A computer-implemented system comprising at least one processor and instructions causing the at least one processor to perform operations comprising:
a) maintaining a repository of fulfillment objects each comprising a language and a region;
b) establishing a user session with a user;
c) determining a user region for the user in association with establishing the user session;
d) identifying one or more fulfillment objects in the repository available for the user region;
e) processing the user session, the user session comprising one or more user requests;
f) applying a language detection model to each request to determine a user request spoken language;
g) applying an understanding module to each request to recommend one or more of the fulfillment objects matching the region for the user; and
h) rendering a response to each request to the user, utilizing the one or more of the fulfillment objects matching the region for the user, in the user request spoken language.

21. One or more non-transitory computer-readable storage media encoded with instructions executable by one or more processors to provide an application comprising:
a) a repository of fulfillment objects each comprising a language and a region;
b) a software module establishing a user session with a user;
c) a software module determining a user region for the user in association with establishing the user session;
d) a software module identifying one or more fulfillment objects in the repository available for the user region;
e) a software module processing the user session, the user session comprising one or more user requests;
f) a software module applying a language detection model to each request to determine a user request spoken language;
g) a software module applying an understanding module to each request to recommend one or more of the fulfillment objects matching the region for the user; and
h) a software module rendering a response to each request to the user, utilizing the one or more of the fulfillment objects matching the region for the user, in the user request spoken language.
